(19) United States
(12) Patent Application Publication
(10) Pub. No.: US 2025/0153075 A1
(43) Pub. Date: May 15, 2025

(54) PROCESS FOR THE SEPARATION OF SMOKE

(71) Applicant: MATERIA NOVA ASBL, Mons (BE)

(72) Inventors: Fabrizio MASERI, Mons (BE); Thomas GODFROID, Mons (BE); Philippe RAMIREZ, Mons (BE); Arnaud KRUMPMANN, Mons (BE)

(21) Appl. No.: 18/838,259

(22) PCT Filed: Feb. 17, 2023
(86) PCT No.: PCT/EP2023/054087

§ 371 Date: Aug. 14, 2024

(30) Foreign Application Priority Data
Feb. 18, 2022 (BE) BE2022/5109

(51) Int. Cl. B01D 21/26; B01D 21/24

(52) U.S. Cl. CPC B01D 21/265; B01D 21/245; B01D 21/2494; B01D 2257/70

(57) ABSTRACT

The current invention relates to a process for the separation of a heterogeneous solid-gas mixture comprising a solid carbon fraction and a gas fraction, said process operating at a high temperature Top and in a low oxygen environment, said process comprising the step of: providing a liquid metal, said liquid metal having a gas-liquid interface; and directing said solid-gas mixture at the gas-liquid interface of said liquid metal.

### FIELD OF THE INVENTION

The present invention relates to a process for the separation of a heterogeneous solid-gas mixture or smoke. In a particular embodiment, the invention relates to a high temperature process operating in a low oxygen environment particularly suitable to capture and concentrate the solid fraction from a solid-gas mixture.

### BACKGROUND

In physical or chemical processing systems that produce gases and particulates, the particulate filtration is accomplished using a gas-solids separation system. The gas-solids separation systems can contain cyclone filters, back-pulse filters, or other filters. For example, filtering the carbon-containing particles from the hydrogen gas that are generated in chemical processing systems is challenging. In some cases, the generated particles are very small (e.g., median particle size below 100 nm), which exacerbates the particle filtration challenges. Some gas-solids separation systems for separating carbon-containing particles from a gas stream use back-pulse filters. In some cases, the back-pulse filters employ heated filters (e.g., heated filter candles). In some of these systems, the back-pulse filters are periodically cleared by blowing gas through the filter candles to dislodge carbon-containing particles (i.e., using a back-pulse that flows gas in the opposite direction the from the filtration direction). Other gas-solids separation systems for separating carbon-containing particles from hydrogen gas use cyclone separators. In some cases, the cyclone separators are also heated.

U.S. Pat. No. 10,781,103 discloses a microwave chemical processing system having a microwave plasma reactor, and a multi-stage gas-solid separation system.

Chemical reactors which convert hydrocarbons to carbon particles generally have issues with carbon deposits fouling and/or clogging the equipment. The deposited carbon layer generally increases the pressure drop and decreases the thermal efficiency of the equipment. Additionally, it makes controlling the process, as the process parameters vary depending on the state of fouling and clogging. This is particularly problematic for plasma reactors where process control is inherently complex. Lastly, removal of carbon deposits generally requires downtime of the equipment.

### SUMMARY OF THE INVENTION

The present invention and embodiments thereof serve to provide a solution to one or more of above-mentioned disadvantages. To this end, the present invention relates to a separation process according to claim 1.

Preferred embodiments of the device are shown in any of the claims 2 to 14. A specific preferred embodiment relates to an invention according to claim 2. Tin, gallium, indium, bismuth, alloys thereof and eutectics thereof are particularly well suited to separate solid carbon. These metals do not readily form carbides, which is desirable to avoid reaction of the solid carbon with the liquid metal. Additionally, these metals do not form stable hydrides at high temperatures, allowing separation of solid carbon from gas mixtures comprising hydrogen.

In a second aspect, the invention relates to a use according to claim 15. The use as described herein advantageously allows effective separation of gaseous mixtures comprising hydrocarbons, hydrogen, nitrogen or argon and solid carbon at a high temperature. This is particularly advantageous to separate solid carbon and gasses following high temperature conversion of hydrocarbons to solid carbon and a gaseous mixture comprising hydrogen.

In a third aspect the present invention relates to a use according to claim 15. The kit/use as described herein provides an advantageous effect

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 (left) schematically presents a cross-section of a separation process according to the present invention wherein the liquid metal has a linear flow pattern.

FIG. 1 (right) schematically presents a top view of a separation process according to the present invention wherein the liquid metal has a linear flow pattern.

FIG. 2 (left) schematically represents a cross-section of a separation process according to the present invention, wherein the liquid metal has a low angular velocity.

FIG. 2 (right) schematically represents a cross-section of a separation process according to the present invention, wherein the liquid metal has a high angular velocity.

### DETAILED DESCRIPTION OF THE INVENTION

The present invention concerns a process for the separation of a heterogeneous solid-gas mixture.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention.

Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention relates to a process for the separation of a heterogeneous solid-gas mixture comprising a solid carbon fraction and a gas fraction, said process operating at a high temperature Tₒₚ and in a low oxygen environment, said process comprising the step of:
Providing a liquid metal, said liquid metal having a gas-liquid interface; and
Directing said solid-gas mixture at the gas-liquid interface of said liquid metal.

In a preferred embodiment, said liquid metal is chosen from the group of tin, indium gallium, bismuth, alloys and eutectics thereof. Particularly preferred liquid metals are pure tin, pure gallium, pure indium, Galinstan alloy (67 wt. % Ga, 20.5 wt. % In, 12.5 wt. % Sn), wood metal also known as Lipowitz' alloy (50 wt. % Bi, 26.7 wt. % Pb, 13.3 wt. % Sn, 10 wt. % Cd). It should be noted that Lipowitz' alloy is toxic which should be considered. In a more preferred embodiment, said liquid metal is at least 30 wt. % tin, more preferably at least 40 wt. % tin, more preferably at least 50 wt. % tin, more preferably at least 60 wt. % tin, more preferably at least 70 wt. % tin, more preferably 25 at least 80 wt. % tin, more preferably at least 90 wt. % tin, more preferably at least 95 wt. % tin, more preferably at least 97 wt. % tin, more preferably at least 98 wt. % tin, more preferably at least 99 wt. % tin, more preferably at least 99.5 wt. % tin. Suitable alloying materials with tin are gallium, indium, silver, copper and lead. Tin is preferred as it can be liquid at reasonable temperatures (i.e. 232° C.). Tin has limited interaction with hydrogen and hydrocarbons at high temperatures. While some hydrides are known, these are not thermodynamically favored and/or require strong reducing agents. Hydrogen can hardly diffuse or dissolve into liquid tin, allowing good separation of these gasses from the liquid metal mixture. Furthermore, tin does not form carbides or hydrides at high temperatures. Liquid tin does not readily wet solid carbon, allowing efficient separation of solid and liquid metal. Liquid tin has a very low vapor pressure at high temperatures; reducing the loss of metal and contamination of the gaseous phase. Liquid metals, such as liquid tin generally have a high density. This increases the buoyancy and thus facilitates separation of solid particles, particularly carbon particles. It also increases the heat capacity of the liquid, improving its function as a working fluid for heat exchangers.

Additional benefits of liquid metals such as tin are high electrical and thermal conductivity. This allows the liquid metal to fill additional functions on top of separation, such as heat exchange fluid and/or electrode (e.g. electrical resistivity of tin between 473 K and 1673 K ranges between 40 to 80 10⁻⁸ Ohm·m).

In a preferred embodiment, said heterogeneous solid-gas mixture has a solid fraction of at least 1 wt. %, more preferably at least 5 wt. %, more preferably at least 10 wt. %, more preferably at least 15 wt. %, more preferably at least 20 wt. %, more preferably at least 25 wt. %, more preferably at least 30 wt. %, more preferably at least 40 wt. %, more preferably at least 50 wt. %. In a preferred embodiment, the solid fraction lies between 1 and 80 wt. %, more preferably between 5 and 75 wt. %, more preferably between 10 and 75 wt. %, more preferably between 20 and 75 wt. %, more preferably between 30 and 75 wt. %, most preferably between 50 and 75 wt. %. Full conversion of hydrocarbons to solid carbon and hydrogen gas results in a 50-75 wt. % solid fraction and is most optimal. However, full conversion is difficult to achieve. As conversion reduces, so does the solid fraction in the mixture as more gaseous hydrocarbons remain therein. Good separation is obtained for all ranges, but energy efficiency decreases as solid fraction decreases.

In another embodiment, liquid metal can be utilized as working fluid to exchange heat. In a more preferred embodiment, heat is exchanged between the gas-solid mixture to be separated and a fluid reactant, preferably a hydrocarbon, which can be converted to hydrogen and solid carbon. In a preferred embodiment, the process further comprises the step of preheating a fluid (that is to say liquid or gaseous) by injecting said fluid into said liquid metal. In a preferred embodiment, said fluid is a reactant (herein “fluid reactant”), more preferably said fluid comprises a hydrocarbon mixture. In embodiments where reactor and separator are combined, this preheating can take place in the same vessel that forms the separating gas-liquid interface. In a further embodiment, said fluid is injected in one injection point, for example in a pipe drilled with a hole diameter of less than 1 mm, but in a more preferred embodiment said fluid is injected at two or more injection points angularly separated by a maximum of 180°, preferably by means of diffusers such as e.g. in sintered ceramics with controlled degree of porosity. This will enable a better distribution of the gas bubbles and avoid that the bubbles rise up too quickly to the surface. In a further preferred embodiment, said fluid is injected tangentially so that a helical flow pattern is obtained. More preferably, the liquid metal is forced in a helical vortex flow around an axis, and the fluid reactant is injected so a counterflow to said helical vortex is achieved. These preferred embodiments improve the micro mixing and heat exchange between the liquid metal and the fluid reactant.

The process or operating temperature Tₒₚ as defined herein refers to an operating temperature measured in the gas phase at the gas-liquid interface of at least 250° C. “High temperature” as defined herein refers to a temperature of at least 250° C. In a preferred embodiment, the operating temperature Tₒₚ is at least 300° C., more preferably Tₒₚ is at least 400° C., more preferably Tₒₚ is at least 500° C., more preferably Tₒₚ is at least 600° C., more preferably Tₒₚ is at least 700° C., more preferably Tₒₚ is at least 800° C., more preferably Tₒₚ is at least 900° C., more preferably Tₒₚ is at least 1000° C., more preferably Tₒₚ is at least 1100° C., more preferably Tₒₚ is at least 1200° C. The separation process as defined herein is suitable for separating reaction mixtures from thermolysis, reductive gasification, cold, hybrid (such as pos-discharge or energetic discharge or microwave discharge) and hot plasma reactors (such as tri-arc plasma reactors). The present separation process is particularly suitable for plasma reactors, as the liquid metal can be utilized as self-repairing electrode and heat-exchange fluid. Additionally, plasma reactors are well suited for conversion of hydrocarbons to solid carbon and hydrogen in a low oxygen environment.

The separation process as defined herein is designed for high temperature treatment of solid carbon and preferably further comprises gaseous hydrogen. As a result, the present process requires a low oxygen environment to prevent oxidation of solid carbon to gaseous CO and/or CO₂ as well as oxidation of hydrogen gas to steam. As further advantage, this prevents formation of substantial amounts of metal oxides. In a low oxygen environment as used herein refers to a concentration of O₂ in the gas mixture of at most 5 v. %, preferably less than 3 v. % oxygen, more preferably less than 1 v. % oxygen, more preferably less than 0.5 v. % oxygen, more preferably less than 0.1 v. % oxygen, more preferably less than 0.05 v. % oxygen, more preferably less than 0.01 v. % oxygen, more preferably less than 50 ppm oxygen, more preferably less than 25 ppm oxygen, more preferably less than 10 ppm oxygen, more preferably less than 5 ppm oxygen, more preferably less than 1 ppm oxygen.

In some embodiments, the input material and/or gas fraction contains CO₂ in an amount of at most 10 v. %, preferably less than 5 v. % CO₂, more preferably less than 3 v. % CO₂, more preferably less than 1 v. % CO₂, more preferably less than 0.5 v. % CO₂, more preferably less than 0.1 v. % CO₂, more preferably less than 0.05 v. % CO₂, more preferably less than 0.01 v. % CO₂, more preferably less than 50 ppm CO₂, more preferably less than 25 ppm CO₂, more preferably less than 10 ppm CO₂, more preferably less than 5 ppm CO₂, more preferably less than 1 ppm CO₂.

In some embodiments, the input material and/or gas fraction contains water (H₂O) in an amount of at most 10 v. %, preferably less than 5 v. % water, more preferably less than 3 v. % water, more preferably less than 1 v. % water, more preferably less than 0.5 v. % water, more preferably less than 0.1 v. % water, more preferably less than 0.05 v. % water, more preferably less than 0.01 v. % water, more preferably less than 50 ppm water, more preferably less than 25 ppm water, more preferably less than 10 ppm water, more preferably less than 5 ppm water, more preferably less than 1 ppm water.

In some embodiments, the input material and/or gas fraction contains water (H₂O) in an amount of at most 5 v. % H₂S, more preferably less than 3 v. % H₂S, more preferably less than 1 v. % H₂S, more preferably less than 0.5 v. % H₂S, more preferably less than 0.1 v. % H₂S, more preferably less than 0.05 v. % H₂S, more preferably less than 0.01 v. % H₂S, more preferably less than 50 ppm H₂S, more preferably less than 25 ppm H₂S, more preferably less than 10 ppm H₂S, more preferably less than 5 ppm H₂S, more preferably less than 1 ppm H₂S. Metals generally do form sulphides, therefor sulphur content of the gas-solid mixture should be kept to a minimum to avoid excessive reaction with the liquid metal.

In a preferred embodiment, the solid-gas mixture to be separated is produced by a plasma reactor or plasma chemical reactor. Plasma reactors or plasma chemical reactors use a plasma source to create a plasma, and the plasma is used to convert an input material into separated components, that is to say “pyrolysis” or “plasmolysis” or “plasmalysis”. In some cases, the separated components include a mixture of solid particles and gaseous products. In such systems, the plasma chemical reactor can be designed to produce gases and particles with desirable properties (e.g., product gas species, product gas purity, particle composition and crystal structure, particle size, surface area, mass density, electrical conductivity, etc.) from a particular input material. The input material properties (e.g., input material species, input material purity, etc.) can also affect the properties of the heterogeneous solid-gas mixture (e.g., product gas species, product gas purity, particle composition and crystal structure, particle size, surface area, mass density, electrical conductivity, etc.). Additionally, in plasma chemical processing systems that produce mixtures of solid particles and gaseous products, the gas-solids separation system is critical. In a preferred embodiment, the input material of said plasma reactor comprises a hydrocarbon fluid, preferably a hydrocarbon gas. In some embodiments, the plasma reactor also includes an inlet configured to receive the input material, where the input material flows through the inlet into the reaction zone, and the plasma through plasmolysis separates the input material into heterogeneous solid-gas mixture (e.g., hydrogen gas and carbon particles). This resulting heterogeneous gas-solid mixture can advantageously be separated by the separation process according to the present invention. Compared to traditional separation techniques, the present invention obtains much better separation of very small particle sizes, such as those in the nm range. Additionally, the high temperatures required for obtaining a plasma combine well with the temperature requirements for liquid metals. In a preferred embodiment, the input material is a hydrocarbon gas, such as CH₄, C₂H₂, C₂H₄, C₂H₆. In some embodiments, the input material is an industrial gas such as natural gas, or bio-gas. In some embodiments, the input material is a mixture of natural gas and hydrogen gas, or a mixture of bio-gas a hydrogen gas. In some embodiments, the process material is methane, ethane, ethylene, acetylene, propane, propylene, butane, butylene, or butadiene, or any mixtures thereof, and output of the plasma chemical reactor is hydrogen, hydrocarbons and particulate carbon, preferably nanoparticulate carbon. The particulate carbon can advantageously be separated from the hydrogen and hydrocarbon fluids using the separation process of the present invention. Natural gas (NG) input material generally contains methane, and ethane.

In a preferred embodiment, a transducer (or sonotrode) is used to inject a well-controlled ultrasounds flux into the liquid metals, in at least one point, with at least 4 identified advantages: i) the cavitation effect induced by moderated ultrasound makes it possible to first generate a greater number of smaller gas bubbles which and allows thus an increased gas-liquid exchange surface, ii) ultrasounds can produce bubbles coalescence leading to larger bubbles moving more slowly into the liquid metal (Stokes law), iii) chock waves induce locally high temperature and pressure favoring crystallized carbon forms at a reasonable mean temperature of the liquid metal, iv) the power of the acoustic waves used and their distribution within the liquid will also significantly influence the number of nucleation sites of carbon particles and their further coalescence and so, to tune their physical and chemical properties.

In another preferred embodiment, the plasma reactor can also be combined ultrasound source in the gas phase or in combination with a liquid metal separator.

NG can also contain other hydrocarbons such as propane, butane and pentane. NG can also contain other species in lower concentrations such as nitrogen and carbon dioxide. In general, the composition of species in natural gas varies by source.

In a further embodiment, the liquid metal can further be utilized as self-repairing electrode for the plasma generating means. In another further embodiment, the liquid metal can be utilized as heat exchange fluid to pre-heat the hydrocarbon inlet of said plasma reactor. In a more preferred embodiment, the separation system and plasma reactor can be combined to a single process step rather than subsequent process steps.

In a particularly favored embodiment, the input material (preferably fluids) of a chemical or plasma reactor may be passed through said liquid metal. This allows highly efficient heat-exchange between the input material and the liquid metal, without requiring the heating of additional equipment and pumping both fluids through said equipment designed to keep the liquid metal and input material separated. Advantageously tin has little interaction with both input and output material for hydrocarbon to solid carbon and hydrogen type reactions;

advantageously permitting direct contact heat exchange.

In a preferred embodiment, the heterogeneous solid-gas mixture comprises hydrogen gas and carbon particles, and the solids loading, in mass of solids per volume of gas, is greater than 0.001 g/L, preferably greater than 0.01 g/L, more preferably greater than 0.05 g/L, more preferably greater than 0.1 g/L, more preferably greater than 0.15 g/L, more preferably greater than 0.2 g/L, more preferably greater than 0.25 g/L, more preferably greater than 1 g/L, more preferably greater than 2 g/L, more preferably greater than 5 g/L, more preferably from 0.001 g/L to 5 g/L, more preferably from 0.001 g/L to 2.5 g/L, more preferably from 0.001 g/L to 1 g/L, more preferably from 0.001 g/L to 0.5 g/L, more preferably from 0.001 g/L to 0.1 g/L, more preferably from 0.01 g/L to 5 g/L, more preferably from 0.01 g/L to 2.5 g/L, more preferably from 0.01 g/L to 1 g/L, more preferably from 0.01 g/L to 0.5 g/L, more preferably from 0.01 g/L to 0.4 g/L, more preferably from 0.01 g/L to 0.3 g/L, more preferably from 0.01 g/L to 0.2 g/L, more preferably from 0.01 g/L to 0.1 g/L, more preferably from 0.1 g/L to 5 g/L, more preferably from 0.1 g/L to 2.5 g/L, more preferably from 0.1 g/L to 1 g/L, more preferably from 0.1 g/L to 0.5 g/L, more preferably from 0.1 g/L to 0.4 g/L, more preferably from 0.1 g/L to 0.3 g/L, more preferably from 0.1 g/L to 0.2 g/L.

In a preferred embodiment, the “solid carbon fraction” or “carbon material” has a ratio of carbon to other elements, except hydrogen, greater than 60%, preferably greater than 70%, more preferably greater than 80%, more preferably greater than 90%, more preferably or greater than 99%, more preferably greater than 99.5%, more preferably greater than 99.7%, more preferably greater than 99.9%, more preferably greater than 99.95%.

Throughout this application, the terms “particle” or “particles” are generic terms that can include any size particles, including nanoparticles and aggregates. The solid carbon fraction or carbon material as defined herein comprises carbon particles. In a preferred embodiment, the solid carbon fraction comprises carbon aggregates, more preferably in a ratio of at least 50%, more preferably 70%, more preferably 80%, more preferably 90%, most preferably 95%. In another preferred embodiment, the solid carbon fraction comprises carbon nanoparticles, in a ratio of at least 50%, more preferably 70%, more preferably 80%, more preferably 90%, most preferably 95%. Carbon aggregates typically have a size from 1 micron to 50 microns, or from 2 microns to 20 microns, or from 5 microns to 40 microns, or from 5 microns to 30 microns, or from 10 microns to 30 microns, or from 10 microns to 25 microns, or from 10 microns to 20 microns. In some embodiments, the size distribution of the carbon aggregates has a 10th percentile from 1 micron to 10 microns, or from 1 micron to 5 microns, or from 2 microns to 6 microns, or from 2 microns to 5 microns. The size of the particles that make up the aggregates can vary in size, and can be smaller than 10 nm or up to hundreds of nanometers in size. In some embodiments, the aggregates are made up of nanoparticles. Nanoparticles have an average diameter in a range from 5 to 500 nm, or from 5 to 250 nm, or from 5 to 100 nm, or from 5 to 50 nm, or from 10 to 500 nm, or from 10 to 250 nm, or from 10 to 100 nm, or from 10 to 50 nm, or from 40 to 500 nm, or from 40 to 250 nm, or from 40 to 100 nm, or from 50 to 500 nm, or from 50 to 250 nm, or from 50 to 100 nm. In some embodiments, the size of aggregates is measured using TEM images. In some embodiments, the size of the aggregates is measured using a laser particle size analyser. In a further preferred embodiment, the carbon particles have a specific surface area measured according to ASTM D6556 between 25 and 125 m²/g, more preferably between 50 and 125 m²/g, more preferably between 75 and 125 m²/g, most preferably between 100 and 125 m²/g.

In a preferred embodiment, the process comprises the step of:
Creating a predictable flow of the liquid metal at said gas-liquid interface. Due to buoyancy as well as other forces, the solid fraction rises to the gas-liquid surface. Advantageously, the flow of the liquid metal at said gas-liquid surface carries the solid fraction to a desired location suitable for separation of said liquid metal and said solid fraction. A predictable flow of said liquid metal also allows for heat transport, which is effective considering liquid metals generally have high heat capacity and high density.

In one embodiment, the gas-liquid interface is substantially horizontal. A horizontal gas-liquid interface can operate at low predictable flow rates, reducing operational costs. It also has less design constraints and simpler operation. This is for example desirable when the heterogeneous solid-gas mixture to be separated contains species which affect or react with the liquid metal; such as sulfur or oxygen containing species; or species which are not readily separated from the liquid metal, in relatively high amounts. As these species affect the physical properties of the liquid metal, a setup which is less constrained by said physical properties may be desirable. In a preferred embodiment, the liquid metal flows at a linear flow rate lower than 2.0 m/s, more preferably lower than 1.5 m/s, more preferably lower than 1.0 m/s.

In a preferred embodiment, the solid-gas mixture is directed at the gas-liquid interface at a speed v₀ between 0.01 and 50 m/s, more preferably v₀ lies between 0.05 and 25 m/s, more preferably v₀ lies between 0.10 and 20 m/s, more preferably Vo lies between 0.50 and 15 m/s, more preferably v₀ lies between 1.00 and 10 m/s, most preferably about 5 m/s.

In another embodiment, the liquid metal rotates at an angular speed ω_{L}. In one preferred embodiment, ω_{L} is sufficiently low to maintain a substantially horizontal gas-liquid interface. In another preferred embodiment, ω_{L} is sufficiently high to form a spiral or helical shaped flow pattern and a cone-shaped gas-liquid interface. In one embodiment, the solid fraction may be separated from the liquid metal at the center of said cone-shaped gas-liquid interface. In another embodiment, the solid fraction may be collected at a tangential edge of said cone-shaped gas-liquid interface. At low angular speeds ω_{L}, the solid fraction accumulates on the edge of the cone-shaped gas-liquid surface; i.e. at the tangential edge of the bowl. At high angular speeds ω_{L}, the solid fraction accumulates near the center of the cone-shaped gas-liquid surface. A difficulty with this design is that the depth of the vortex and the height of the cone is dependent on the angular speeds ω_{L} as well as the physical properties of the liquid metal. In a further preferred embodiment, the collection mechanism at the center of the cone-shaped gas-liquid interface can be adjusted in height. An adjustable collector may be adjusted through a control mechanism, or self-adjusted for example by using buoyancy effects. Generally low angular velocities are observed at ω_{L} substantially lower than 1 rad/s. High angular velocities are observed at velocities higher than 1 rad/s, preferably higher than 1.3 rad/s. It is clear to the skilled person that the actual transition between the regime for low and high angular speeds depends on the choice of liquid metal as well as the design parameters of the container and to be obtained vortex. The angular velocities as described herein are the angular velocities of the liquid, as measured at the liquid-gas interface. The rotation of the liquid metal can be achieved through different means as is known in the art. For example, any pump suitable for liquid metals would be satisfactory. Especially when the liquid metal is used as heat transfer fluid in an external heat exchanger, a pump is required to move the liquid metal to said external heat exchanger regardless. In such a case, pumping is likely preferred. Alternatively, propeller, directly moving the liquid by means of current and/or magnetic fields, a rotating drum with internal fins is also viable.

In a preferred embodiment, the rotation of the liquid metal is achieved by an impeller. Generally, impeller rotation speeds with an impeller will need to be higher to obtain these angular speeds at the liquid-gas interface. Depending on the design of the propellor and the liquid utilized, these may be significantly higher. In a particular preferred embodiment, the propeller has vertical blades. Vertical blades have a surface defining a plane, wherein the axis of rotation is parallel with said plane, preferably the axis of rotation falls within said plane. Vertical blades were found to be highly beneficial to increasing the angular velocity of the liquid itself, in particular when compared to tilted blades and/or vanes common in the art. As a result, a helical or cone-shaped gas-liquid interface is obtained at much lower impeller rotation rates.

In a further preferred embodiment, the impeller has substantially vertical blades, preferably vertical blades, wherein the impeller rotates at a rate of at least 50 rpm, more preferably at least 100 rpm, more preferably 150 rpm, more preferably 200 rpm, more preferably 250 rpm, more preferably 300 rpm, more preferably 350 rpm, more preferably 400 rpm. The applicant found that from 50 rpm using vertical blades, liquid tin will start to show a cone-shaped gas-liquid interface. This cone-shaped gas-liquid interface still has a low curvature and remained to an impeller rotation speed of roughly 100 rpm. When the speed was further increased above 100 rpm, the curvature of the gas-liquid interface increased substantially. By 300 rpm, a very high curvature was observed. Consequently, the use of vertical blades allows for high curvature gas-liquid interfaces at relatively low impeller RPM. Furthermore, this limited the energy used on diffusive mixing.

In a different further preferred embodiment, the impeller has tilted blades and/or vanes, wherein the impeller rotates at a rate of at least 50 rpm, more preferably at least 100 rpm, more preferably 150 rpm, more preferably 200 rpm, more preferably 250 rpm, more preferably 300 rpm, more preferably 350 rpm, more preferably 400 rpm. The applicant found that from 200 rpm using tilted blades or vanes, liquid tin will start to show a cone-shaped gas-liquid interface. This cone-shaped gas-liquid interface still has a low curvature and remained to an impeller rotation speed of roughly 400 rpm. Consequently, the use of tilted blades and/or vanes allows for high impeller RPM as well as high mixing energy while keeping the gas-liquid interface at a low curvature.

It is clear that these impeller RPM rates are indicative; impeller design, vessel design, their relative positions and the liquid of choice all impact the hydrodynamic regime obtained. However, the above-mentioned examples do show that high mixing can be obtained even in combination with a low curvature of the gas-liquid interface. Likewise high curvature of the gas-liquid interface can be obtained even at relatively low impeller RPM.

In a further embodiment, the solid-gas mixture is directed at the gas-liquid interface under grazing angle a, wherein said grazing angle a is measured relative to an axis parallel to gravity. Preferably, a is between 5° and 85°, more preferably between 15° and 80°, more preferably between 30° and 80°, more preferably between 45° and 80°, most preferably between 55 and 80°.

In a further embodiment, the solid-gas mixture is directed at the gas-liquid interface as a vortex flow. Said vortex flow is understood as a flow which revolves around an axis line, wherein the flow has a translational component parallel to said axis line and wherein said axis line is directed at said gas-liquid interface. In a preferred embodiment, said vortex flow is characterized by angular component ω_{g}, wherein said angular component ω_{g} has the opposite direction of the angular speed of the liquid metal. That is to say, these vortices of the liquid metal and the heterogeneous gas-solid mixture have opposing angular components (counterflow). This counterflow improves separation at a trade-off for energy efficiency. In another embodiment, the vortices of the liquid metal and the heterogeneous solid-gas mixture have angular components in the same direction (parallel flow). These embodiments improve energy-efficiency at a trade-off for efficacy of separation.

In a further embodiment, the solid fraction may comprise a catalyst. The separation process according to the present invention allow separation of said catalyst from the gases. Further separation from the rest of the solid fraction, regeneration if required and recycling of the regenerated catalyst can then follow.

In another embodiment, the liquid metal may comprise a catalyst. More preferably, the liquid metal may be utilized as transport medium for said catalyst. Active catalysts are transition metals such as nickel, iron, copper, silver, cobalt, palladium, platinum and rhenium that can be solubilized and/or form eutectics with the low temperature molten metal (Sn, Ga, Bi, In). These catalytic liquid alloys modify the morphology and crystallographic properties of the formed carbon species (carbon blacks, nanotubes, nanofibers, graphenes and graphites).

In a preferred embodiment, the liquid metal is held in a container or bowl produced from graphite, carbon-composite, ceramic, ceramic composite, aluminosilicate, glass, quartz or a mixture thereof. These materials can be operational at high temperature and will not interact with liquid metals.

In a preferred embodiment, the liquid metal bath has a depth of at least 0.001 m, more preferably a depth of at least 0.03 m, more preferably a depth of at least 0.05 m, more preferably a depth of at least 0.10 m. Preferably the liquid metal bath has a depth of at most 1.0 m, more preferably at most 0.5 m, more preferably at most 0.3 m, more preferably at most 0.25 m.

In a preferred embodiment, the liquid metal bath has a width of at least 0.10 m, more preferably a width of at least 0.15 m, more preferably a width of at least 0.20 m, more preferably a width of at least 0.25 m. Preferably the liquid metal bath has a width of at most 0.50 m, more preferably a width of at most 0.40 m, more preferably a width of at most 0.30 m, more preferably a width of at most 0.25 m.

In a preferred embodiment, the liquid metal can further be utilized as an electrode. In a further preferred embodiment, the liquid metal can be utilized as a self-healing electrode (e.g., for arc plasma reactor). As the liquid metal can trivially be replenished and the liquid-gas interface does not degrade under bombardment of solid particles, liquid metal can advantageously be used as self-repairing electrode. Additionally, the liquid metal may be utilized as radiation reflector (e.g. UV light, infrared or even for microwave guiding).

In a second aspect, the present invention relates to the use of a process according to the first aspect for the separation of solid carbon from gaseous mixtures. Preferably, said gaseous mixtures comprise hydrocarbons, hydrogen, nitrogen or argon.

In a preferred embodiment, the process is used in combination with flue gas coming from a thermolysis reactor, gasification reactor (particularly in reductive mode), a cold plasma reactor, a hybrid plasma reactor or a hot plasma reactor.

However, it is obvious that the invention is not limited to this application. The method according to the invention can be applied in all sorts of separation processes.

The invention is further described by the following non-limiting examples which further illustrate the invention, and are not intended to, nor should they be interpreted to, limit the scope of the invention.

The present invention will be now described in more details, referring to examples that are not limitative.

### DESCRIPTION OF FIGURES

With as a goal illustrating better the properties of the invention the following presents, as an example and limiting in no way other potential applications, a description of a number of preferred applications of the method for examining the state of the grout used in a mechanical connection based on the invention, wherein:

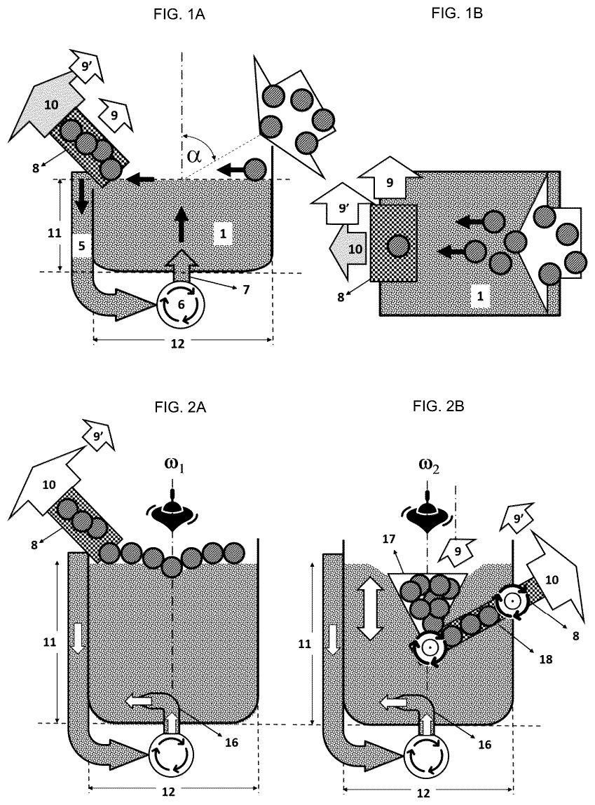

FIG. 1 (left) schematically presents a cross-section of a separation process according to the present invention wherein the liquid metal has a linear flow pattern.

FIG. 1 (right) schematically presents a top view of a separation process according to the present invention wherein the liquid metal has a linear flow pattern.

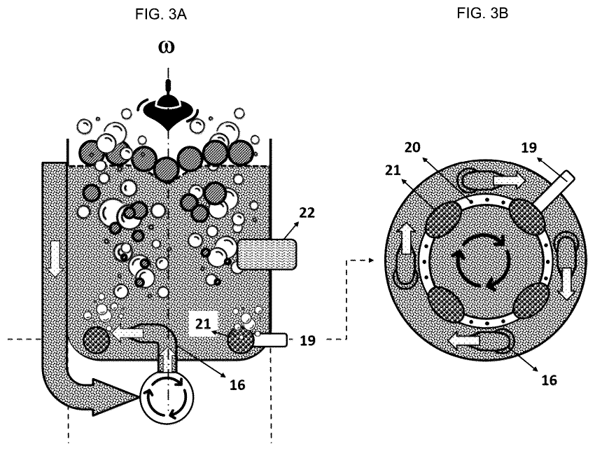

FIG. 2 (left) schematically represents a cross-section of a separation process according to the present invention, wherein the liquid metal has a low angular velocity.

FIG. 2 (right) schematically represents a cross-section of a separation process according to the present invention, wherein the liquid metal has a high angular velocity.

FIG. 3 (left) schematically represents a cross-section of a separation process according to the present invention, wherein the solid-gas mixture is injected in rotating liquid metal.

FIG. 3 (right) schematically presents a top view of a separation process according to the present invention, wherein the solid-gas mixture is injected in rotating liquid metal.

FIG. 1 shows liquid metal bath (1) which separates the liquid-gas mixture (2) comprising gas (3) and solids (4). The solid particles are pushed to the gas-liquid interface and float on said gas-liquid interface due to buoyancy. A collector (8) is used to pick up the floating (and agglomerated) solid particles while the gas fraction is released or removed. Various embodiments of the collector (8) are suitable, such as filters having holes or slits. The liquid metal is separated into flow channel (5) through which it is pumped back by pump (6) to the liquid metal bath (1) at the liquid metal inlet (7), resulting in a steady linear flow at the gas-solid interface.

FIG. 2 shows two embodiments with an angular flow regime; one with low angular velocity ω₁ (left) and one with high angular velocity ω₂ (right). At low angular velocity, the particles agglomerate at the tangential edge of the bowl. This allows a collector such as described for FIG. 1 may be used and located at any tangential edge of the container. The collector may be a sieve, particularly if the liquid metal does not wet the solid particles and thus separation of liquid metal and solid particles is easily obtained. The solid particles are removed from the collector 8 towards storage 10. The gases 9′ can be released back, totally or partially removed. At high angular velocity, the solid particles agglomerate at the center of the cone-shaped liquid-gas interface. The collector must thus be installed near the axis of rotation with a well-defined shape as to not prevent the formation of the vortex. For example, an overflow-collector such as collecting cone 17 can be utilized. Collecting cone 17 is connected to transporting means 18; which result in a sieve 8 to separate from any remaining liquid metal. The resulting agglomerated solid can be removed and stored (10). As in previous embodiments, gases 9′ can be released back, totally or partially removed.

FIG. 3 shows a side view (left) and a top view (right) of an embodiment with an angular flow regime. Reactive gas is introduced through submerged reaction gas injector 21 into the rotating liquid metal at a pressure larger than that corresponding to the liquid metal height 11. In order to ensure a uniform gas distribution of the reactive gas into the liquid metal, in a preferred embodiment, multiple injectors (20 or 21) are used, which transform the liquid metal into a well-controlled liquid foam enabling appropriate thermal exchanges between the reactive gas and the liquid metals. Ducts and injector are made of materials that can operate at high temperature, that do not interact with the considered liquid metals. At least one annular duct 20 is used for reactive gas injection, pierced with several properly oriented holes/slits of suitable size (typically 0.1 to 10 mm). In the embodiment, special porous parts 21 are used to introduce particle-free gases. The distribution of gas bubble size statistics and their spatial distribution in the foam is a key element. In a preferred embodiment, a transducer (or sonotrode) 22 enables to inject a controlled ultrasounds flux into the liquid metals, in at least one point.

The present invention is in no way limited to the embodiments described in the examples and/or shown in the figures. On the contrary, methods according to the present invention may be realized in many different ways without departing from the scope of the invention.

1. A process for the separation of a heterogeneous solid-gas mixture comprising a solid carbon fraction and a gas fraction, said process operating at a high temperature Tₒₚ and in a low oxygen environment, said process comprising the step of:
providing a liquid metal, said liquid metal having a gas-liquid interface; and
directing said solid-gas mixture at the gas-liquid interface of said liquid metal.

2. The process according to claim 1, wherein said liquid metal is chosen from the group of tin, gallium, bismuth, alloys and eutectics thereof, preferably the liquid metal is tin.

3. The process according to claim 2, wherein said liquid metal is a eutectic of tin or bismuth and indium.

4. The process according to claim 1, wherein said operating temperature Top is at least 300° C., preferably at least 600° C.

5. The process according to claim 1, wherein the gas fraction comprises hydrocarbons, hydrogen, nitrogen or argon, preferably hydrocarbons and hydrogen.

6. The process according to claim 1, the process further comprising the step of:
Creating a predictable flow of the liquid metal at said gas-liquid interface.

7. The process according to claim 1, wherein the gas-liquid interface is substantially horizontal.

8. Process according to claim 1, wherein the liquid metal rotates at an angular speed ω_{L}, preferably ω_{L} is sufficiently high to forming a spiral or helical shaped liquid metal flow pattern and a cone-shaped gas-liquid interface.

9. The process according to claim 8, wherein the solid fraction is collected at a tangential edge of the cone shaped gas-liquid interface.

10. The process according to claim 8, wherein the solid fraction is collected at the center of said cone-shaped gas-liquid interface.

11. The process according to claim 1, wherein the solid-gas mixture is directed at the gas-liquid interface under a grazing angle a, wherein said grazing angle a is measured relative to an axis parallel to gravity.

12. The process according to claim 1, wherein the solid-gas mixture is directed as a vortex flow.

13. The process according to claim 8, wherein the solid-gas mixture is directed as a vortex flow with an angular component ω_{g}, wherein said angular component ω_{g} has the opposite direction of the angular speed of the liquid metal ω_{L}.

14. The process according to claim 1, wherein the liquid metal is held in a container, wherein said container is produced from graphite, carbon-composite, ceramic, ceramic composite, aluminosilicate, glass, quartz or a mixture thereof.

15. The process according to claim 1, wherein the liquid metal is further used as electrode.

16. The process according to claim 1, wherein the liquid metal is further used as working fluid for a heat exchanger.

17. Use of a process according to claim 1, for the separation of solid carbon from gaseous mixtures comprising hydrocarbons, hydrogen, nitrogen or argon.
